(19) United States
(12) Patent Application Publication
(10) Pub. No.: US 2006/0214418 A1
(43) Pub. Date: Sep. 28, 2006

(54) Arrangement with a tubular element

(75) Inventors: Sergio Pascuzzi, Griesheim (DE); Thomas Roesch, Linsengericht-Grossenhausen (DE); Artur Poeppel, Gelnhausen (DE)

Correspondence Address: BUCHANAN, INGERSOLL & ROONEY PC, POST OFFICE BOX 1404, ALEXANDRIA, VA, 22313-1404, US

(73) Assignee: VERITAS AG, Gelnhausen (DE)

(21) Appl. No.: 11/385,686

(22) Filed: Mar. 22, 2006

(30) Foreign Application Priority Data
Mar. 24, 2005 (DE) 10 2005 013 859.4

(51) Int. Cl. F16L 47/02; B32B 37/00

(52) U.S. Cl. 285/21.1; 156/294; 156/296

(57) ABSTRACT

The present invention relates to an arrangement with a tubular element, preferably a pipe or a hose, and a coupling device, which exhibits a tubular section, the internal diameter of which is larger than the external diameter of the tubular element and in which the tubular element is in some sections arranged in the tubular section. To improve this type of arrangement, provision is made according to the present invention in that a pre-fabricated, preferably annular adhesive element of essentially fusible adhesive is arranged between the tubular element and the tubular section.

The present invention relates to an arrangement with a tubular element, preferably a pipe or a hose, and a coupling device, which exhibits a tubular section, the internal diameter of which is larger than the external diameter of the tubular element and in which the tubular element is arranged in some sections in the tubular section.

This type of arrangement is, for example, known from DE 19945218. There a coupling component is described which exhibits an outer tubular section and an inner coupling connection piece. Between the outer tubular section and the coupling connection piece a space is formed in which an end section of a fluid line is concentrically arranged. The fluid line is pushed onto the coupling connection piece. To produce a firm joint between the pipe and the coupling connection piece, provision is made in that, before the pipe is pushed onto the pipe connection piece, first a ring of a firm, moulded, fusible adhesive is applied, which essentially fills the space between the outer tubular section and the coupling connection piece. To fit the pipe in the coupling component, the adhesive is melted while the pipe is pushed onto the coupling connection piece. During fitting, the front end face of the pipe pushes against the adhesive and displaces it so that once the coupling connection piece is fully pushed onto the pipe, the adhesive is displaced into the remaining gap between the pipe and the outer tubular section.

The displacement of the adhesive during the introduction of the pipe with simultaneous heating of the adhesive leads to substantial movement within the adhesive. Furthermore, it cannot be excluded that, depending on the location of the tolerances of pipe, coupling connection piece and the tubular outer section and the resulting pressure relationships, adhesive may flow out from the joint under pressure. Similarly, there is the risk of air inclusions.

The object of the present invention is therefore to improve an arrangement of the type mentioned in the introduction such that the disadvantages from the state of the art are overcome.

The object is solved according to the present invention in that a preformed, preferably annular, adhesive element of essentially fusible adhesive is arranged between the tubular element and the tubular section.

This solution is simple and has the advantage that first the pipe is introduced into the space within the tubular section and the annular adhesive element is arranged between the pipe and the tubular section either before the introduction of the pipe or after the introduction of the pipe. Through this arrangement it is then possible to melt the adhesive in a state where the components are already aligned with respect to one another. In this way substantial movements of the adhesive during the joining process between the pipe and the coupling device are avoided. Consequently, since the annular adhesive element consists of fusible adhesive, it is also possible to pre-prepare the individual parts, that is the pipe, coupling device and adhesive element, and to make the actual joint when the final installation situation occurs and, for example, the parts are mutually aligned. In this way particularly radial tolerances can be compensated which arise due to the actual installation situation. The adhesive can then adapt itself without problem to the respective installation situation.

In an advantageous further development the adhesive element can consist of moulded adhesive. In this way the adhesive element can be produced accurate to size and can be easily fitted.

In an advantageous further development of the present invention the coupling device can comprise an essentially radially extending shoulder section on which the adhesive element contacts in the axial direction of the tubular section. In this way an adhesive space can be defined which is bordered by the tubular section and the radially extending section. Fitting can also be simplified in this manner.

The tubular element can make contact to the shoulder section to establish positioning.

In addition it may be advantageous if the internal diameter of the tubular section is slightly larger than the external diameter of the adhesive element. The fitting of the adhesive element can then be simplified. It may also be found convenient if the internal diameter of the adhesive element is slightly larger than the external diameter of the tubular element. Also, this then facilitates the introduction of the adhesive element into the space between the tubular element and the tubular section without problem.

Furthermore, it may prove to be advantageous if the adhesive element is essentially cylindrical in shape. Fitting can then be simplified in this manner.

Simplification of fitting can also be achieved if the adhesive element comprises an adhesive which melts when heat is applied.

To obtain improved adhesion between the coupling device and the tubular element, the adhesive element can exhibit a section which at least in some sections extends radially inwards. Then it may prove to be favourable if the face side of the tubular element contacts the section which extends radially inwards at least in some sections. In this embodiment it is however necessary to first fit the adhesive element before introducing the tubular element. On the other hand, the face-side contact of the tubular element with the adhesive and furthermore the contact between the adhesive and the coupling device can improve the adhesion.

In an advantageous further development, the coupling device can comprise a coupling connection piece which extends into the tubular element in sections. Also, the joint between the coupling device and the tubular element can be improved in this way.

The coupling connection piece can here be formed by an annularly running groove arranged in the radially extending section of the coupling device. A coupling connection piece can be simply and cost-effectively realised in this manner.

To prevent the adhesive from flowing out of the joint between the coupling device and the tubular element, the axial length of the adhesive element can be less than the axial length of the tubular section.

Furthermore, it may be an advantage if the adhesive element and the tubular element consist of plastic or comprise plastic, preferably a polymer plastic. In this way a very strong adhesive joint can be achieved. It may be particularly advantageous if the adhesive element and the tubular element consist of the same plastic. Similarly, it may also be favourable if the adhesive element, tubular element and coupling element comprise the same plastic, at least in some regions.

Furthermore, the adhesive can comprise electrically conducting particles. The adhesive can then, for example, be melted by induction. Moreover, it is conceivable that also the coupling element and/or the pipe as well as the adhesive element can be implemented electrically conducting. In this way an electrically conducting joint between the coupling device, the tubular element and the adhesive can be ensured after fitting.

Furthermore, a method is claimed for producing a joint of an arrangement according to one of the aforementioned claims in which first the adhesive element comprising the moulded fusible adhesive and the tubular element are introduced into the tubular section and then the adhesive is melted.

By this method, as also by claim 1, the advantages of the present invention can be achieved. In particular this method facilitates a final joint of the tubular element and coupling device in the actual installation situation and thus enables the compensation of radial tolerances in the installation positions of the coupling device and the tubular element.

In addition, it may prove to be favourable if the tubular element and the coupling device are aligned with respect to one another before the adhesive is melted.

Furthermore, it may prove to be favourable if the tubular element essentially protrudes vertically upwards during melting. In this way a uniform flow of the adhesive around the tubular element can be achieved.

Furthermore, it may prove to be advantageous if the tubular element is placed onto the coupling connection piece before the adhesive element is slid on.

In the following the functioning principle of the present invention is explained in more detail based on embodiments.

The following are shown:

FIG. 1 the arrangement according to the present invention before fitting;

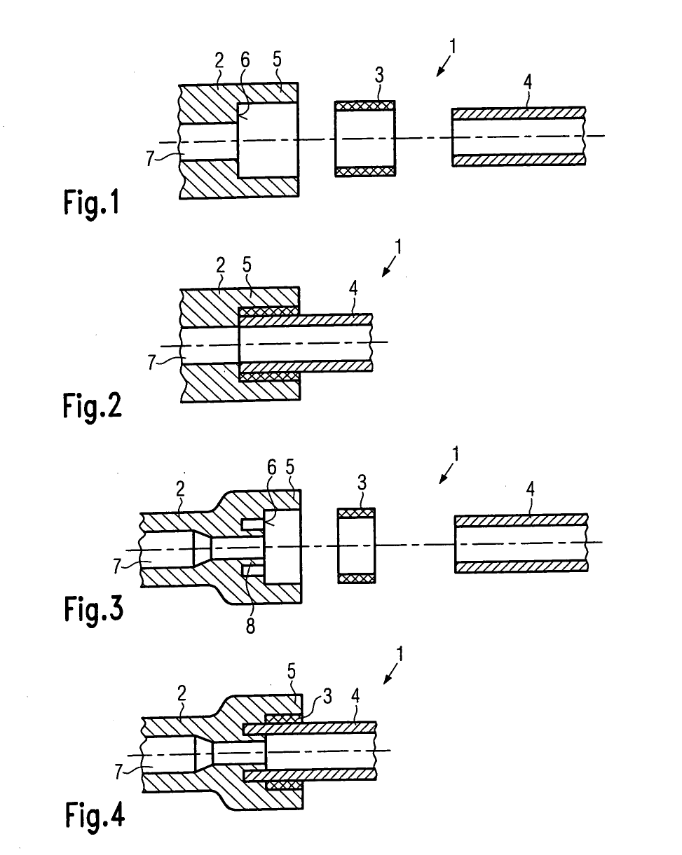

FIG. 2 the arrangement according to the present invention from FIG. 1 after fitting;

FIG. 3 a second embodiment of the arrangement according to the present invention before fitting;

FIG. 4 the arrangement from FIG. 3 after fitting;

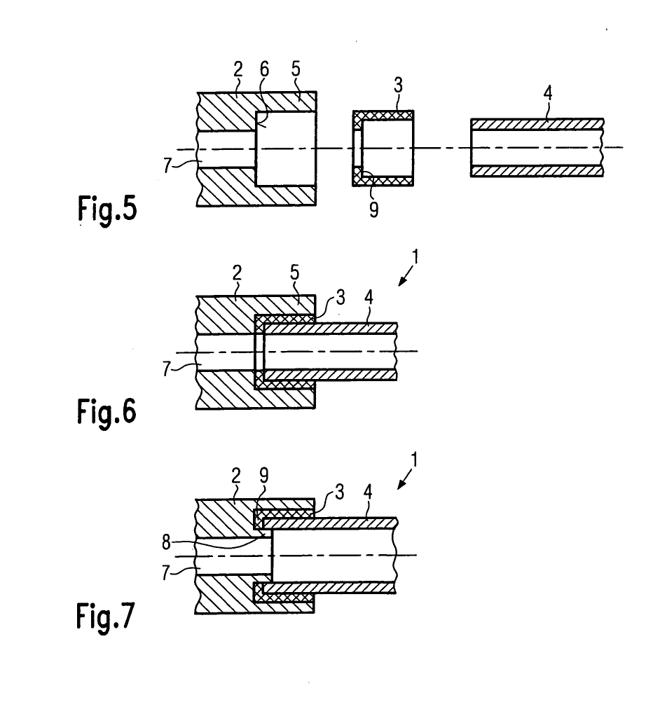

FIG. 5 a third embodiment of the arrangement according to the present invention before fitting;

FIG. 6 the arrangement from FIG. 5 after fitting; and

FIG. 7 a fourth embodiment of the arrangement according to the present invention after fitting.

FIG. 1 shows the arrangement 1 according to the present invention in a sectional view before fitting, i.e. before assembly. In detail the following is illustrated: a coupling device 2, a cylindrical annular adhesive element 3 and a tubular element 4, which is here formed as a rigid pipe. Alternatively, flexible pipes are also conceivable. In this embodiment the coupling device 2 and the tubular element 4 consist of plastic, e.g. a polyolefin, such as, for example, polypropylene. Alternatively, other materials are also conceivable. For example, the coupling device and/or the tubular element can consist of metal or an elastomer. Furthermore, multi-layer pipes or hoses are also conceivable.

The adhesive consists of a plastic which melts when heated and which is moulded into a cylindrical adhesive element. The adhesive element can also be produced by the injection moulding method or by extrusion. Alternatively, the adhesive element can also be formed in a plurality of parts, e.g. from two half-shells or a number of segments. Also, metal particles can be present in the adhesive element, in particular, to promote induction heating. Otherwise, a commonly used fusible adhesive from the state of the art is used.

The adhesive element can also comprise electrically conductive particles, thus making the adhesive electrically conducting. Furthermore, the coupling element and the pipe can be formed to be electrically conducting so that the complete arrangement is electrically conducting.

In the first embodiment the coupling device 2 has a tubular section 5 adjacent to a radially extending shoulder section 6. Concentric to the tubular section a pipe section 7 is also provided which opens into the shoulder section 6, so that a fluid can be conveyed through the coupling device.

The internal diameter of the tubular section is here dimensioned such that it is slightly larger than the external diameter of the cylindrical adhesive element. Thus the coupling device and an adhesive element can be inserted one into the other without problem. Furthermore, the tubular element is configured such that its external diameter is slightly smaller than the internal diameter of the adhesive element so that also the tubular element and the adhesive element can be inserted one within the other without problem.

In the assembled state, that is when the coupling device, adhesive element and tubular element have been suitably inserted one within the other as shown in FIG. 2, melting of the adhesive element then follows in the next step so that the adhesive joint between the tubular element and the coupling device is established.

In the following the operating and functional principles of the present invention are explained in more detail:

First, the individual parts, that is a coupling device, adhesive element and tubular element are assembled, whereby it is unimportant whether the adhesive element or the tubular element is first introduced into the tubular section of the coupling device. If the tubular element is to be introduced first, it is convenient if the adhesive element is formed from a plurality of parts, e.g. by two half-cups. In the assembled state the arrangement of the coupling device, adhesive element and tubular element assumes the configuration as illustrated in FIG. 2. In the next step heat can then be applied to the adhesive element so that the adhesive element melts and produces an adhesive joint between the tubular element and the coupling device. Since there is some play between the adhesive element, coupling device and tubular element, first an alignment of the tubular element with respect to the coupling device can be carried out. Tolerances can be compensated in this way. Thus, the arrangement 1 can be supplied ready made-up and the coupling device and tubular element can be brought into their final installation positions. Through the later adhesion a stress-free joint between the coupling device and tubular element can be ensured.

In the following a second embodiment of the present invention is explained. To avoid repetition however, only the differences to the first embodiment are highlighted. In particular, the same components also have the same reference symbols.

In the second embodiment a coupling connection piece 8 is also provided onto which the tubular element is pushed. The coupling connection piece 8 is formed by an annular groove formed in the shoulder section 6. The dimensions of the groove can here be selected such that the tubular element can be inserted without problem. The assembly and adhesion then occur in the same manner as for the first embodiment.

In the following a third embodiment of the present invention is explained. Also in this embodiment only the differences to the first embodiment are pointed out. In the third embodiment the adhesive element is formed slightly differently. It additionally has a section 9 extending radially inwards, with which the adhesive element is brought into contact with the shoulder section 6 of the coupling device 2. In addition, the tubular element contacts on its face side the section 9 which extends radially inwards. In this manner face side adhesion of the tubular element to the coupling device is also ensured.

In FIG. 7 a fourth embodiment is additionally illustrated after fitting. Here too, the same components are labelled with the same reference symbols. In contrast to the third embodiment, this embodiment also has a coupling connection piece 8.

1. Arrangement with a tubular element, preferably a pipe or a hose, and a coupling device, which exhibits a tubular section, the internal diameter of which is larger than the external diameter of the tubular element and in which the tubular element is arranged in some sections in the tubular section, wherein a pre-fabricated, preferably annular adhesive element, essentially of fusible adhesive, is arranged between the tubular element and the tubular section.

2. Arrangement according to claim 1, wherein the adhesive element consists of moulded adhesive.

3. Arrangement according to claim 1, wherein the coupling device exhibits an essentially radially extending shoulder section which the adhesive element contacts in the axial direction of the tubular section.

4. Arrangement according to claim 1, wherein the internal diameter of the tubular section is slightly larger than the external diameter of the adhesive element.

5. Arrangement according to claim 1, wherein the internal diameter of the adhesive element is slightly larger than the external diameter of the tubular element.

6. Arrangement according to claim 1, wherein the adhesive element is essentially cylindrical in shape.

7. Arrangement according to claim 1, wherein the tubular element is essentially arranged concentrically with respect to the tubular section.

8. Arrangement according to claim 1, wherein the adhesive element exhibits a section which extends radially inwards at least in some sections.

9. Arrangement according to claim 1, wherein the tubular element exhibits on the face side, at least in some sections, a section which extends radially inwards.

10. Arrangement according to claim 1, wherein the tubular element contacts on the face side, at least in some sections, the section which extends radially inwards.

11. Arrangement according to claim 1, wherein the coupling device comprises a coupling connection piece, which extends into the tubular element in some sections.

12. Arrangement according to claim 1, wherein the coupling connection piece is formed by an annular groove arranged in the radially extending section of the coupling device.

13. Arrangement according to claim 1, wherein the axial length of the adhesive element is less than the axial length of the annular section.

14. Arrangement according to claim 1, wherein the coupling element exhibits plastic, preferably polymer plastic.

15. Arrangement according to claim 1, wherein the tubular element exhibits plastic, preferably polymer plastic.

16. Arrangement according to claim 1, wherein the adhesive exhibits electrically conducting particles.

17. A method of producing a joint of an arrangement according to claim 1 in which first the moulded adhesive element and the tubular element are introduced into the tubular section and then the adhesive is melted.

18. Method according to claim 17, wherein the tubular element and the coupling device are aligned with respect to one another before the adhesive is melted.

19. Method according to claim 17, wherein during the melting of the plastic the tubular element protrudes essentially vertically upwards.

20. Method according to claim 17, wherein the tubular element is placed on the coupling connection piece before the adhesive element is melted.
